(19) United States
(12) Patent Application Publication
(10) Pub. No.: US 2002/0053903 A1
(43) Pub. Date: May 9, 2002

(54) Angle measuring device

(75) Inventor: Volker Kempe, Lieboch (AT)

Correspondence Address: CHAPMAN AND CUTLER, 111 WEST MONROE STREET, CHICAGO, IL, 60603, US

(73) Assignee: austriamicrosystems AG, Unterpremstatten (AT)

(21) Appl. No.: 10/036,055

(22) Filed: Oct. 19, 2001

(30) Foreign Application Priority Data
Oct. 23, 2000 (AT) GM 787/2000

(51) Int. Cl. G01B 7/30

(52) U.S. Cl. 324/207.25; 324/207.2

(57) ABSTRACT

In a measuring device for the non-contact detection of the absolute angle of rotation of a shaft, such as a steering column, at multiple revolutions, magnetic, optical or magneto-optical structures are arranged on the shaft or a part connected therewith. The shaft carries a thread which is in engagement with a rider or index finger. At least one sensor is provided to detect the magnetic, optical or magneto-optical structures as well as the displaced position of the rider or index finger.

### BACKGROUND OF THE INVENTION

1. Field of the Invention

The invention relates to a measuring device for the non-contact detection of the absolute angle of rotation of a shaft, in particular a steering column, at multiple revolutions.

2. Prior Art

A number or proposals have already been known for the non-contact detection of the angle of rotation of a shaft. The known embodiments, for instance, comprise counting wheels whose rotation corresponds to a change in the angle of rotation to be measured. About the circumference of such counting wheels are arranged recesses or teeth, respectively, which may be detected by optical sensors or by inductive proximity switches. The thus triggered counting pulses must subsequently be further processed electronically. Measuring devices of this type are suitable to detect and store incremental angular changes. In order to obtain information on the absolute instantaneous angle of rotation, such measuring devices also have to detect the direction of rotation, the absolute angle of rotation being calculatable by the summation of the incremental angular changes. In principle, the known measuring devices are also suitable to detect angles of rotations at multiple revolutions of a shaft, whereby it is sufficient in that case to measure the angle of rotation and the direction of rotation absolutely in the range between 0 and 360° and calculate back to the overall angular change occurred. The drawback of that mode of procedure, besides the difficulty to detect the transition from one range of revolution to another range of revolution unambiguously under all moving conditions, consists in that the system has to memorize the angular position present in the moment of deactivation in order to be able to calculate back the same on the point of reference at a new activation. Rotations effected in the idle state are, however, not detected at all by incremental angle measurements.

With the majority of angle measuring systems including multiple revolutions such as, e.g. steering column rotary angle measuring systems, the absolute measurement of the angular position within the pregiven range of multiple revolutions is, however, indispensable at any time and after every activation of the system. For the absolute measurement of angles of rotation at multiple revolutions, reduction gears have, therefore, been used, for instance, in the form of planetary gears in which the multiple revolution range is imaged, either directly or in steps, on a full revolution or on partial revolutions that may be calculated back. The angular positions of the individual toothed gears in that case may be detected by the aid of optical or magnetic sensors and evaluated accordingly. Such systems comprising precise mechanical gear reductions are, however, expensive, sensitive to mechanical loads and prone to aging. Moreover, they require considerable installation volume or space.

### SUMMARY OF THE INVENTION

The present invention aims to provide a measuring device for the non-contact detection of the absolute angle of rotation of a shaft and, in particular the steering column of a vehicle, at multiple revolutions, which does not need any expensive precision gears or mechanically moved precision parts. Since the measuring device cannot be arranged on the end of the head spindle in a number of applications such as, e.g., the multiple revolution measurement of steering columns, the measuring device according to the invention is to be arrangeable in a compact manner around the shaft and, in particular, exhibit small built-in dimensions. Moreover, merely sturdy and cost-effective measuring procedures are to be employed to measure distances and angles. Furthermore, the invention is based on the object to provide an angle measuring system for multiple revolutions, which enables the absolute measurement of an angular position within the pregiven multiple revolution range, wherein the measuring system is to yield correct measured results even after the deactivation and new activation of the system as well as during rotations effected in the idle state.

To solve this object, the measuring device according to the invention essentially consists in that magnetic, optical or magneto-optical structures are arranged on the shaft or a part connected therewith, that the shaft carries a thread which is in engagement with a rider or index finger capable of being displaced in the axial direction of the shaft, and that at least one sensor is provided to detect the magnetic, optical or magneto-optical structures as well as the displaced position of the rider or index finger. By arranging magnetic, optical or magneto-optical structures on the shaft or a part connected therewith such as, for instance, a disc or a cylinder dish, the precisely clear and absolute measurement of the angle of rotation has become feasible within a range of a single revolution, i.e., within a range of between 0 and 360°. In doing so, one or several sections of the magnetic, optical or magneto-optical structures on the shaft are detected by appropriately provided sensors, wherein the structures are configured in a manner that each measuring line and hence each angle of rotation is allocated a structural section characteristic merely of that particular angle of rotation. Thus, a measuring device is provided, in which an absolute angle measurement is directly obtained within a range of between 0 and 360° and which, therefore, does not require the summation, and further processing in electronic circuits, of individual measured values or counted pulses, as is the case with incremental angle detection. No memorization of the measured value detected last is required, because the instantaneous angle of rotation can be detected immediately upon deactivation and reactivation of the system, on account of the characteristic section of the magnetic, optical or magneto-optical structure detected by the sensor. In this manner, changes in the angle of rotation effected even in the idle state will not falsify measurements.

In order to enable the measurement of the number of revolutions, or in combination with the above-described absolute angle measurement also of angles of rotation in a range larger than 360° or smaller than 0°, the measuring device according to the invention is configured in a manner that the shaft carries a thread which is in engagement with a rider or index finger capable of being displaced in the axial direction of the shaft. By the axial displacement of the rider or index finger as a function of the overall revolution angle, a coarse measurement of the overall revolution angle is effected, whereby the axial displacement of the rider or index finger is detected by the sensor. In a preferred manner, the rider or index finger is designed as a sleeve surrounding the shaft and provided with an internal thread in engagement with the thread of the shaft. In order to detect the axial displacement position of the rider or index finger or the cylindrical sleeve, respectively, by the sensor, the rider or index finger or the cylindrical sleeve is provided with a magnetic, optical or magneto-optical structure which, depending on whether the cylindrical sleeve or a rider or index finger rotates additionally to the axial displacement or not, is formed on the full circumference or only on the segment permanently present below the sensor. In the main, the combination of a precise absolute angle measurement in a range of between 0 and 360°, i.e., within the range of a single revolution, with an angle measurement effected over the total angle measurement range comprising several revolutions on account of the axial displacement of the rider or index finger or the sleeve, respectively, produced a measuring arrangement which enables the precise absolute angle measurement even at multiple revolutions, a correct measured value being available also after the deactivation and reactivation of the system without storage of the angular value measured last. In doing so, the angle measurement is only very rough due to the axially parallel displacement of the rider or index finger or the sleeve, respectively, and it is, therefore, feasible to use simple and cheap threads or mechanical transmission, for instance, in the form of plastic injection moldings. A coarse measurement at the preciseness of, for instance, half a revolution will suffice, since such a coarse measurement is merely used to determine the number of revolutions, the precise absolute angle measurement being effected on account of the magnetic, optical or magneto-optical structure arranged on the shaft, as already described above. A coarse measurement may be used to assist the absolute angle measurement, for instance, in order to eliminate possible ambiguities in the segmental structuring of the absolute angle measurement, whereby a slightly higher accuracy will then be required to determine the number of partial revolutions corresponding to a segment of the absolute angle measurement.

The detection of the magnetic, optical or magneto-optical structures according to a preferred further development of the invention is effected along a measuring line extending in the axial or approximately axial direction of the shaft, whereby the sensor may, furthermore, be designed as a sensor array arranged in parallel with the measuring line. In that case, the structures to be detected may be designed, for instance, as magnetic field structures made of soft or hard magnetic materials. They may be formed by abrupt field or magnetizing transitions or by smoother transitions as are caused, for instance, in dense alternate magnetization. In the event of a magnetic structure made of a soft magnetic material, an excitation magnet is arranged behind or beside the sensor system. A particularly simple embodiment will result if the structure is devised in a manner that it transforms the angular position directly into a distance measure. To this end, the measuring device preferably is configured such that the magnetic, optical or magneto-optical structures are formed by transition lines arranged helically or spirally between regions of different magnetic, optical or magneto-optical properties. To this end, it is, for instance, feasible to apply magnetic structures which comprise at least one readily detectable field or magnetizing variation, for instance one which, at one revolution of the shaft, possesses a distance to a reference line which grows monotonously along the generating line of the shaft, thus enabling the unambiguous allocation of an angle value to a distance value. In that case, an essential advantage is, after all, reached in that a reference line or region capable of being detected by the sensor is arranged on the shaft or the part connected therewith to determine a reference position, the reference line or region preferably being realized as a reference ring located in a normal plane laid on the axis of the shaft. Consequently, an axial movement of the sensor system relative to the shaft will not influence the measuring accuracy as long as the sensor array scans the entire magnetic structure, since it is not the absolute position of the characteristic magnetic structure which is determined, but only the relative distance between the structure and a reference point.

The detection of the distinct magnetic, optical or magneto-optical structures according to the invention is effected by the aid of a sensor array comprised of, e.g., n Hall elements, which are preferably arranged linearly with one or several rows of sensors being applicable. When using magnetic sensors, Hall sensors are preferably employed, which measure the magnetic field component perpendicular to the sensor surface. The sensor array may be oriented in parallel with a generating line of the shaft surface or along any other appropriately arranged measuring line. For cost reasons and reasons of the monolithic integratability of the sensors in one or at least a few integrated circuits, the length of the sensor array must be kept as small as possible. On the other hand, this length must cover at least the height of the magnetic, optical or magneto-optical structure, which is necessary to determine the respective angle. Hence results, for instance in the event of a helical-line-shaped magnetic field variation and a reference ring, that said length is larger than the sum of the lead of the helical line, the axial extension of the structural portion of the reference ring region and a safety distance that enables the attachment of a helical line structure and the reference ring structure in a manner largely free of disturbances. For array lengths to be sought in practice, e.g., of below 10 mm, and a lead for the helical line of 5 mm, the requirement of the accuracy of the distance measurement is, thus, Δh<Δα×5 mm/360°, which, for instance, at a required angle accuracy of 1° would require a distance measuring accuracy of better than 14 μm.

Such accuracies may, however, be difficult to reach in the event of magnetic structures simple to realize and the related field quantities ranging in the order of dozens to hundreds of gausses as well as in the event of sensors that are simple to realize and cheap and whose geometric extensions themselves range in the order of several 10 to 100 μm. For that reason, it is preferably proceeded in a manner that the angle measurement within a range of rotation is effected by measuring the angle in partial segments of the range of revolution as well as determining the associated partial segment independently of the former. To this end, the configuration preferably is devised such that separate magnetic, optical or magneto-optical structures are arranged on the shaft or the part connected therewith, which are formed by structural patterns recurring in the circumferential direction. If a structure transforming the angle information into a distance information is used for each of the recurring structural patterns and the same partial segment height is available for measurement, the demand on the accuracy of the distance measurement will be reduced approximately by a factor m, where m represents the number of segments distributedly arranged about the circumference. For the coarse measurement of an angle, which serves to determine the respective partial segment, only approximately 2× m angular positions need be resolved. The structure used for the coarse angle measurement likewise calls for a predetermined axial height, which, however, may be kept small on account of the low requirement of accuracy.

The allocation of the results of the precise angle measurements to the respective partial segments as well as the calculation of the angle of revolution in the optionally present overlapping regions of the partial segments is effected by simple logical and arithmetical operations. The partial overlapping of the segments may be necessary, because distortions restricting the measuring accuracy will occur on the end of magnetic transition structures. Overlapping ensures that in the event of local measurements, e.g. of the zero crossings of the field, at least one perfect measured value will always be available. If a known, e.g. periodical, structure is integrally measured, overlapping may be obviated, since the phase position of such a structure may be clearly determined by measurement over a full segment period or only parts of the same.

As already mentioned, the detection of the number of revolutions, or optionally the respective sector, is effected by the aid of a rider or index finger capable of being displaced in the axial direction. To this end, the configuration may be further developed in a manner that the rider or index finger is directly connected with the sensor such that an axial displacement of the overall sensor occurs as a function of the angle of rotation. The revolution-dependent displacement of the sensor is detected by determining the position of a reference ring relative to any desired zero point defined on the sensor, and is calculated back to the respective angular position via the pitch. The precise absolute measurement within one revolution is again effected via the measurement of the distance to the reference structure, which measurement in the instant case may be disturbed by the movement of the sensor as opposed to the stationary sensor. Unlike the stationary sensor, this variant is, moreover, sensitive to mounting tolerance changes or tiltings caused by said movement, thus requiring precise and hence expensive guides and/or slip-free reduction gears. On the other hand, operation is feasible with a shorter and hence cheaper sensor array than that used with the stationary variant. It is, therefore, advantageous primarily for mean accuracies and angular variations that are not too fast.

### DESCRIPTION OF THE DRAWINGS

In the following, the invention will be explained in more detail by way of exemplary embodiments schematically illustrated in the drawing, wherein:

FIG. 1 is a partial view of the measuring device according to the invention;

FIG. 2 is a developed view of the cylinder according to FIG. 1;

FIG. 3 illustrates a first embodiment of the measuring device according to the invention;

FIG. 4 illustrates a second embodiment of the measuring device according to the invention; and

FIG. 5 shows an alternative configuration comprising a cylinder dish.

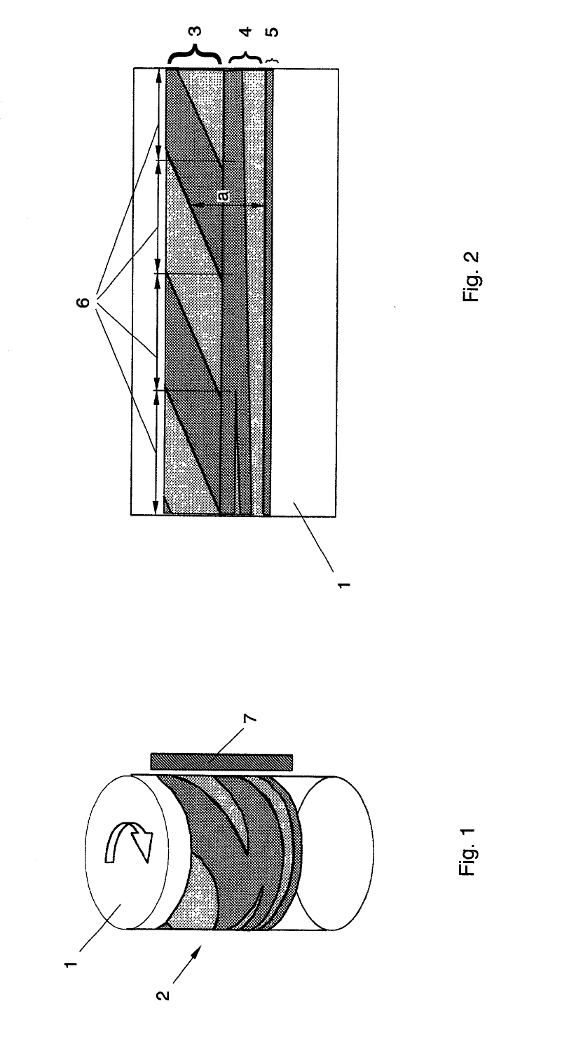

In FIG. 1, a partial section of a shaft, e.g. the steering column of a motor vehicle, is denoted by 1. About the circumference of the shaft 1 are arranged magnetic structures 2 which, as is more clearly apparent from the developed view of the cylinder according to FIG. 2, are comprised of several regions 3, 4 and 5 mutually adjoining in the axial direction of the shaft. The magnetic structure 3 is comprised of several structural patterns recurring in the circumferential direction, with a total of four segments 6 being arranged about the circumference of the shaft 1. These magnetic structures 3 comprise simply detectable field or magnetizing changes which, at a rotation of the shaft, exhibit a distance a to the reference structure 5 monotonously growing along the generating line of the shaft 1, thus enabling the unambiguous allocation of an angle value to a distance value. The measurement of the absolute angle becomes thereby feasible by means of a sensor system comprising a sensor array 7, whereby an unambiguous value may be detected within a segment 6 in the configuration illustrated in FIG. 2. In order to enable the respective allocation to the respective segment, a reference structure 4 is provided, which is formed by a helical transition line between regions of different magnetic properties. The helical line in this case extends about the total circumference such that an unambiguous allocation to the respective segment is feasible. Due to lower demands on the angular resolution, region 4 may have a smaller axial height than region 3.

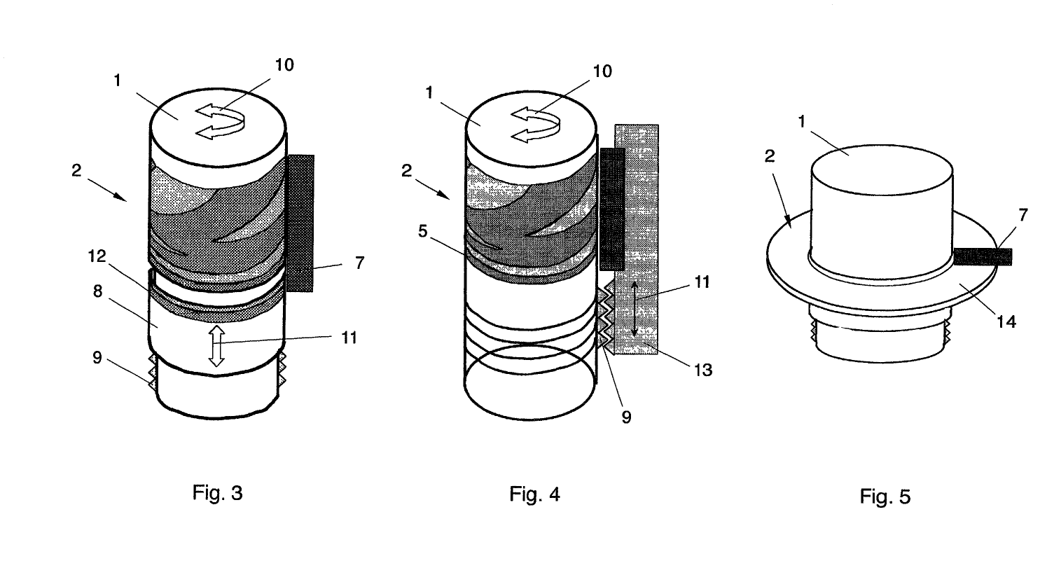

From FIG. 3 the overall measuring system is apparent, wherein, in addition to the magnetic structure illustrated in FIG. 1, also a cylindrical sleeve 8 is visible, whose internal thread engages in the external thread 9 of the shaft 1. A rotation of the shaft in the sense of arrow 10 causes the cylindrical sleeve 8 to be axially displaced in the sense of double arrow 11 in a manner so as to enable the detection of this axial movement by the sensor system 7. To this end, a magnetic ring structure 12 is attached to the cylindrical sleeve 8. The measurement of the displaced position of the cylindrical sleeve 8 gives a coarse information on the number of revolutions of the shaft 1 such that, in combination with the precise and absolute angle detection in a range of between 0 and 360°, i.e., within the range of a single revolution, also the overall revolution angle can be absolutely measured over several revolutions. The reference structure 4 may be omitted, if the overall system according to FIG. 3, which comprises a movable cylindrical sleeve, allows the determination of the number of revolutions to precisely 360°/n, where n is the number of segments for the absolute angle measurement in the range of 0 to 360°.

FIG. 4 depicts an alternative embodiment of the measuring system, in which the external thread 9 of the shaft 1 cooperates with a rider or index finger or a carrier 13 for the sensor array 7. There, the revolution-dependent vertical displacement of the sensor array is detected by determining the position of the reference ring 5 relative to a zero point defined anywhere on the sensor array 7, and is calculated back to the respective angular position via the pitch of the thread.

FIG. 5 depicts an alternative embodiment in which the magnetic structure may be arranged on a cylinder dish 14. In such a configuration, the magnetic structure 2 applied on the cylinder dish 14 may, for instance, be arranged spirally.

What I claim is:

1. A measuring device provided in a shaft arrangement including a shaft means, such as a steering column, for the non-contact detection of the absolute angle of rotation of said shaft means at multiple revolutions, which measuring device comprises
a plurality of magnetic, optical or magneto-optical structural means arranged on said shaft means,
a rider or index finger capable of being displaced in the axial direction of said shaft means into a displaced position,
a shaft means thread provided on said shaft means for engagement with said rider or index finger, and
at least one sensor means arranged to detect said plurality of magnetic, optical or magneto-optical structural means as well as said displaced position of said rider or index finger.

2. A measuring device as set forth in claim 1, wherein said shaft means comprises a shaft and a part connected with said shaft and said plurality of magnetic, optical or magneto-optical structural means is arranged on one of said shaft and said part connected with said shaft.

3. A measuring device as set forth in claim 1, wherein said rider or index finger is designed as a sleeve surrounding said shaft means and carrying an internal thread, said internal thread being in engagement with said shaft means thread.

4. A measuring device as set forth in claim 1, wherein said rider or index finger is connected with said sensor means.

5. A measuring device as set forth in claim 1, further comprising a measuring line extending in the axial direction of said shaft means and wherein said sensor means is arranged along said measuring line.

6. A measuring device as set forth in claim 1, further comprising a measuring line extending in the axial direction of said shaft means and wherein said sensor means is designed as a sensor array arranged in parallel with said measuring line.

7. A measuring device as set forth in claim 1, wherein said magnetic, optical or magneto-optical structural means are formed by transition lines arranged helically or spirally between regions of different magnetic, optical or magneto-optical properties.

8. A measuring device as set forth in claim 1, further comprising a reference means provided on said shaft means and capable of being detected by said sensor means to determine a reference position.

9. A measuring device as set forth in claim 8, wherein said reference means is a reference line.

10. A measuring device as set forth in claim 8, wherein said reference means is a reference region.

11. A measuring device as set forth in claim 8, wherein said shaft means has a shaft means axis and said reference means is designed as a reference ring located in a plane extending normal to said shaft means axis.

12. A measuring device as set forth in claim 8, wherein said shaft means comprises a shaft and a part connected with said shaft and said reference means is arranged on one of said shaft and said part connected with said shaft.

13. A measuring device as set forth in claim 1, wherein said sensor means comprises Hall sensors.

14. A measuring device as set forth in claim 1, further comprising separate magnetic, optical or magneto-optical structural means arranged on said shaft means and formed by structural patterns recurring in the circumferential direction of said shaft means.

15. A measuring device as set forth in claim 14, wherein said shaft means comprises a shaft and a part connected with said shaft and said separate magnetic, optical or magneto-optical structural means are arranged on one of said shaft and said part connected with said shaft.
